(19) United States
(12) Patent Application Publication
(10) Pub. No.: US 2010/0294941 A1
(43) Pub. Date: Nov. 25, 2010

(54) Dual Photons Emission Computed Tomography System

(76) Inventors: Keh-Shih Chuang, Hsinchu (TW); Hsin-Hon Lin, Changhua (TW)

Correspondence Address: LIN & ASSOCIATES INTELLECTUAL PROPERTY, INC., P.O. BOX 2339, SARATOGA, CA, 95070-0339, US

(21) Appl. No.: 12/471,316

(22) Filed: May 22, 2009

(51) Int. Cl. G01T 1/161

(52) U.S. Cl. 250/363.04; 250/363.1

(57) ABSTRACT

A dual photons emission computed tomography (DuPECT) system is provided. The present invention uses certain isotopes that emit at least two photons during the decay for the purpose of emission source positioning. The system includes a plurality of modular detectors connected to a coincident circuit, and each modular detector is equipped with a collimator to determine the direction of the incident photon trajectory. When the modular detectors simultaneously detect the signals of two photons issued by the isotopes, the source position is located at the intersection of the trajectories of two photons. The modular detectors can be arranged around the object to be detected according to the shape of the object and is particularly suitable for imagining of regional organs and small animals.

### FIELD OF THE INVENTION

The present invention generally relates to a dual photons emission computed tomography (DuPECT) system, applicable to isotopes able to emit at least two photons during the decay for the purpose of emission source positioning.

### BACKGROUND OF THE INVENTION

The positron emission tomography (PET) and single photon emission computed tomography (SPECT) are two common nuclear medical imaging technologies. SPECT has the advantages of wider range of usable radiopharmaceuticals and more cost effective than PET.

SPECT system uses collimator to constrain the incident direction of the photons and uses gamma ray project imaging of different directions to construct 3-dimensional tomography image. The biggest problem of collimator is that the spatial resolution depends on the distance between the emission source and the collimator, leading to the inconsistency of system spatial resolution.

The conventional SPECT system requires to place the heavy collimator and the detector around the object to be detected; thus, complicated mechanical gantry is required to fasten the detector for achieve the required precision. Furthermore, attenuation correction is another issue for the quantitative analysis of SPECT system. Because the exact emission source position cannot be obtained from the projected data, the attenuation correction remains an unsolved problem for the SPECT system.

SPECT system evaluates the physiological functions by measuring the concentration of the radioisotopes injected into the body. By rotating the parallel scintillation camera around the object to be detected, the gamma ray emitted by the radioisotopes is detected. A planar image, called scintigram, is the photon spatial distribution image detected at a specific angle. A plurality of scintigrams taken at different angles form a full circular image. Then, the scintigrams are re-assembled to compute the 3-dimensional distribution of the radioisotope. Because of the effect of tissue attenuation, the re-assembled gamma ray image from SPECT system is not linear to the activity distribution of the radioisotope on the patient. The result is that the tomography slice cannot accurately reflect the actual internal activity distribution.

### SUMMARY OF THE INVENTION

The primary object of the present invention is to provide a dual photons emission computed tomography (DuPECT) system, by using the fact that some isotopes, such as, ¹¹¹In, ¹²⁵I, that can emit two or more photons during decay, to assist in emission source positioning.

The DuPECT system of the present invention includes a plurality of modular detectors connected to a coincident circuit, and each modular detector is equipped with a collimator to determine the direction of the incident photon trajectory. Two types of collimators can be used. One is the slot collimator and the other type is the hole collimator. The hole collimator further includes parallel collimator, pinhole collimator or converging collimator. In other words, the detector equipped with a hole collimator is a hole detector, and the detector equipped with a slot collimator is a slot detector.

DuPECT system of the present invention has the following advantages:
1. Stationary: in conventional SPECT system, the scanner must rotate around the object to be detected to obtain projected image. As collimator is generally heavy, a shift in center of mass is inevitably occur when SPECT system rotates, leading to errors. On the other hand, the DuPECT system of the present invention computes the geometrical intersection to position the emission source without the necessity to obtain the projection information from all angles to reconstruct the image. Hence, the DuPECT system is a stationary system without the need of a mechanical gantry for rotation.
2. Adaptable: DuPECT system uses modular detector as a detection unit, and each detection unit can operate independently. The detection unit can be placed at any location around the object to be detected. Hence, the DuPECT system can be placed very close to the object to be detected to improve the sensitivity.
3. Extendable: each detection unit operates independently and each detection unit can be added to or removed from the DuPECT system as required.
4. No need for image reconstruction.
5. Quantitative analysis is possible.

Because the emission source is located at the intersection of a line and a plane, the image can be updated when an event is detected. When the emission source of an event is known, the attenuation coefficient and the geometrical efficiency can be computed and directly updated on the image.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of an embodiment of a DuPECT system according to the invention;

FIG. 2 shows a schematic view of an embodiment of modular detector of FIG. 1 being either a hole detector or a slot detector;

FIG. 3 shows a schematic view of isotope ¹¹¹In emitting two gamma rays during decay;

FIG. 4 shows a schematic view of a slot detector detecting the emission source of a photon;

FIG. 5 shows a schematic view of slot detector and hole detector positioning emission source according to the present invention;

FIG. 6 shows a schematic view of converting a conventional PET system into a DuPECT system according to the present invention;

FIG. 7 shows a schematic view of a hole detector detecting in a DuPECT system converted from conventional PET according to the present invention;

FIG. 8 shows a schematic view of combining a slot detector to convert SPECT into a DuPECT system according to the present invention;

FIG. 9 shows a schematic view of the present invention applied to a thyroid tomography scanning; and

FIG. 10 shows a schematic view of the present invention applied to a abreast tomography scanning.

### DETAILED DESCRIPTION OF THE PREFERRED EMBODIMENTS

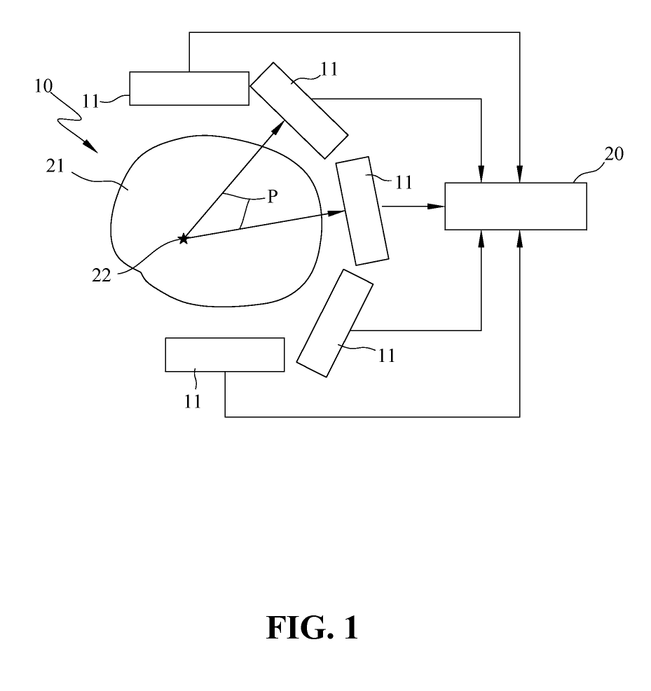

FIG. 1 shows a schematic view of an exemplary embodiment of a dual photons emission computed tomography (DuPECT) system according to the present invention. DuPECT system 10 of the present invention includes a plurality of modular detectors 11 connected to a coincidence circuit 20. Modular detector 11 includes a collimator to define the trajectory of the incident photon. Modular detectors 11 can be arranged around object 21 to scan object 21 according to the shape of object 21 to be detected. Modular detector 11 detects photon signal P of isotope 22 and feed back to coincidence circuit 20. It is worth noting that the number of the modular detector is not limited to any specific number. More modular detectors can be added to or removed from the system for different applications. The present embodiment shows 5 modular detectors.

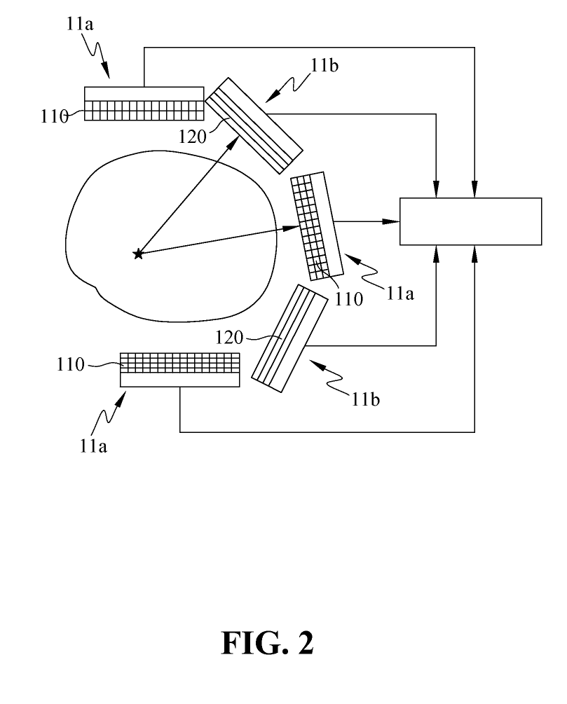

Modular detector 11 can be either a hole detector or a slot detector. For example, in the present embodiment, the first modular detector, the third modular detector and the fifth modular detector can be hole detectors, while the second and the fourth modular detectors are slot detectors. FIG. 2 shows a schematic view of an embodiment of an embodiment of the modular detector of FIG. 1 is either a hole detector 11a or a slot detector 11b, arranged in an alternating manner; i.e., a hole detector is followed by a slot detector. Hole detector 11a includes a hole collimator 110, and slot detector 11b includes a slot collimator 120. Hole collimator 110 can be a parallel collimator, a pinhole collimator or a converging collimator.

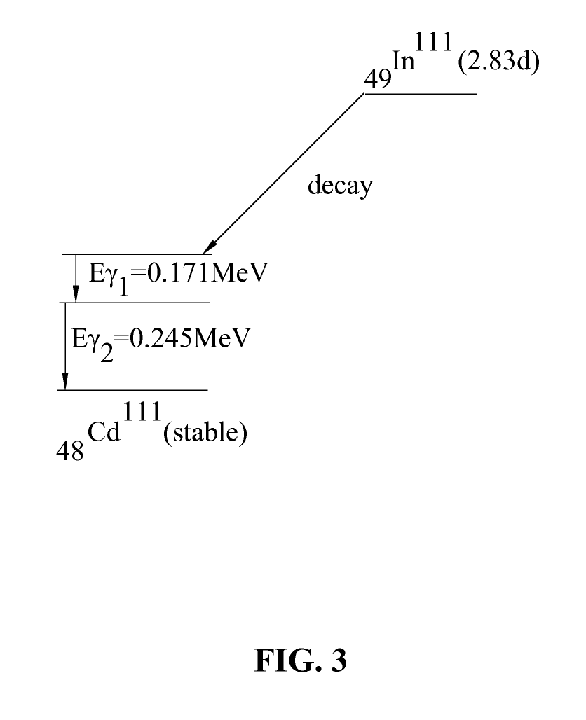

FIG. 3 shows a schematic view of two isotopes used in DuPECT system according to the present invention. As shown in FIG. 3, some isotope, such as, ¹¹¹In, ¹²⁵I, can emit at least two photons during decay. For example, isotope ¹¹¹In emits two gamma rays Eγ1, Eγ2 with energy 171 keV and 245 keV, respectively, during the electronic capture (EC) decay, as shown in FIG. 3. Isotope ¹²⁵I emits a gamma ray with energy 35.5 keV accompanied by x-ray photon of energy ranging from 27 keV to 32 keV. Although the photon energy emitted by ¹²⁵I is low and not suitable for patient examination, the isotope is suitable for investigation of small animal or human organs. Also, as the half life of ¹²⁵I is 59.4 days, this isotope is suitable for long period study.

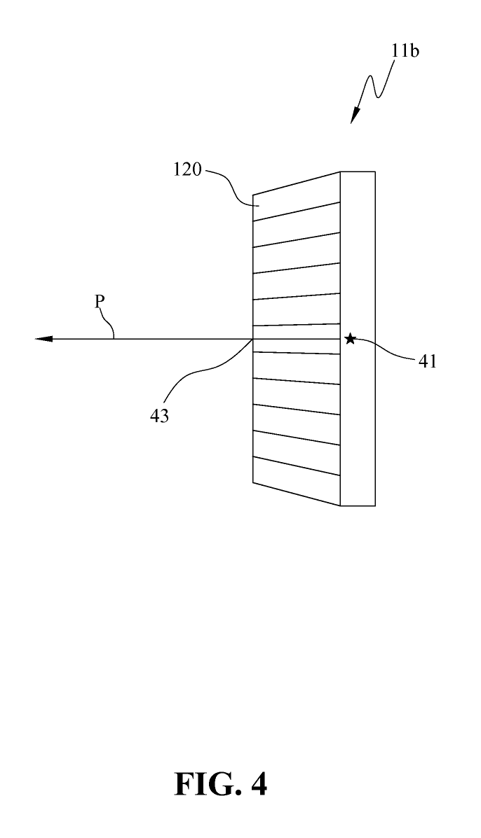

FIG. 4 shows a schematic view of the incident photon on the hole detector according to the present invention. Hole detector 11b detects the trajectory of incident photon P falls on the intersection point of crystal 41 and center 43 of the diameter of slot collimator 120.

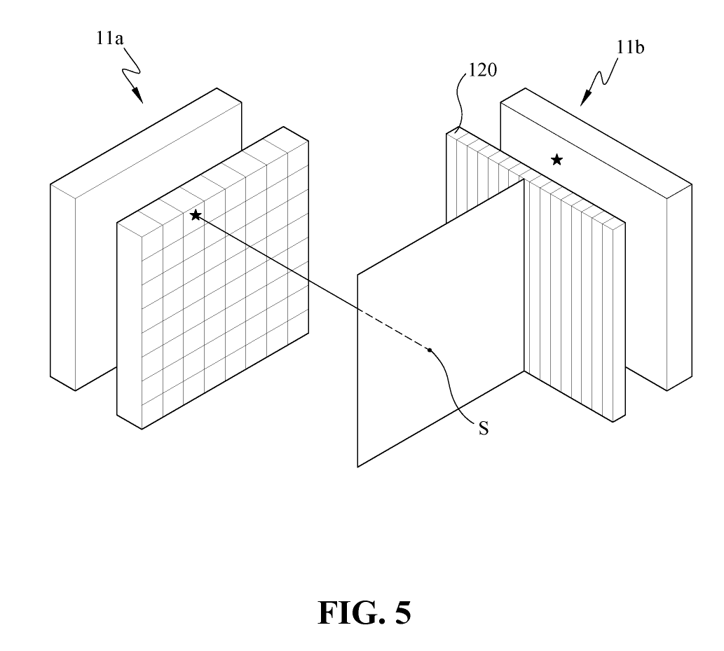

FIG. 5 shows a schematic view of the slot detector and the hole detector positioning the emission source according to the present invention. Slot detector 11b detects the position of the emission source of the photon being on the plane defined by slot collimator 120 and the detected position of the photon. If hole detector 11a and slot detector 11b simultaneously detect the emission source of the two photons, the emission source position is on the intersection S of the line defined by hole detector 11a and the plane defined by slot detector 11b.

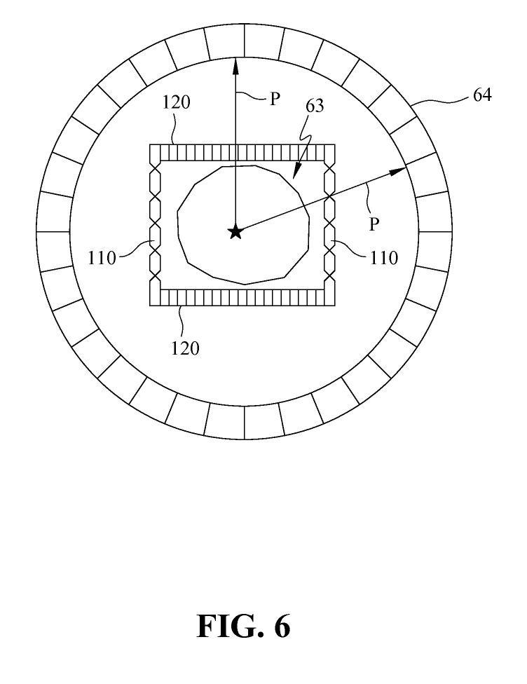

FIG. 6 shows a schematic view of converting a conventional PET into a DuPECT system according to the present invention. As shown in FIG. 6, a collimator system is used to combine a plurality of slot collimators 120 and a plurality of pinhole collimators 110 so that a standard PET system can be converted into a DuPECT system. In the conventional PET system, plural pinhole collimators 110 and plural slot collimators 120 are placed between object 63 to be detected and detection ring 64 so that photon P can penetrate pinhole collimators 110 and slot collimators 120, and return to detection ring 64.

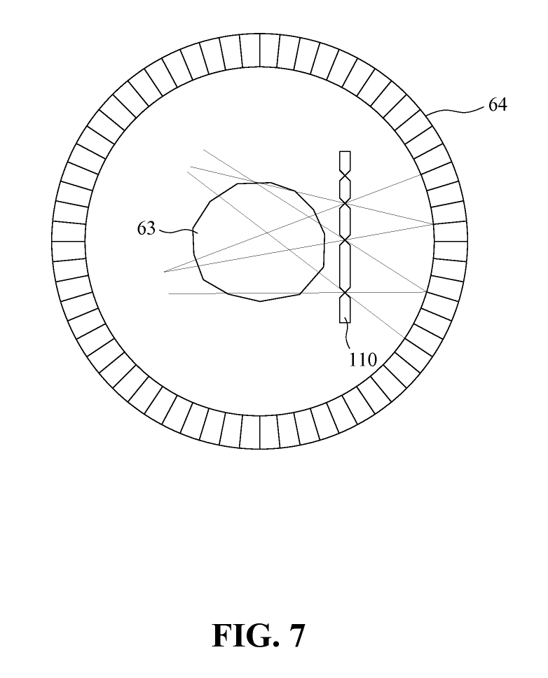

FIG. 7 shows a schematic view of the detection of a pinhole collimator in a DuPECT system modified from a conventional PET system according to the present invention. As shown in FIG. 6, pinhole collimators 110 are arranged in a manner that the projections of object 63 to be detected through pinhole collimators 110 will not overlap. Pinhole collimators 110 are placed as close to object 63 as possible to improve the escape possibility of the photons. This embodiment is suitable to the animal research.

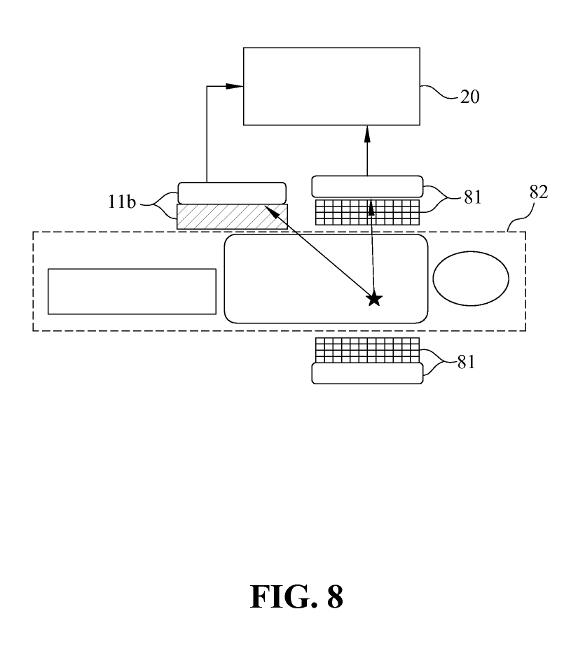

FIG. 8 shows a schematic view of combining slot detector to convert the current SPECT into a DuPECT system of the present invention, by combining slot detector to the SPECT. Slot detector 11b and SPECT 81 are connected to coincidence circuit 20. Slot detector is placed on the side of SPECT in a non-coplanar manner so as not to interfere with the rotation of SPECT gantry 82 will occur. The data can be obtained in two modes. One is the stationary mode where SPECT and slot detector 11b stay stationary, and the image is generated by directly computing the intersection of the trajectories of two photons detected by SPECT and the slot detector.

The other is the dynamic mode, where only SPECT rotates and the slot detector stays stationary. Two data sets can be used in this mode. The first is the data set collected by SPECT alone, and the second data set is the synchronous data collected by SPECT and slot detector. The SPECT data is the conventional sonogram, which can be used for reconstruction and generation of SPECT image. Because the two photons need to arrive simultaneously, the synchronous data has less photons than the SPECT data. The synchronous data can also be used to generate image. The SPECT image includes attenuation phantom image, while the synchronous image is more accurate in positioning the emission source, and yet having more noise signal. The synchronous image can be used to perform the initial estimation of the SPECT image reconstruction to obtain the higher quality image. The synchronization between SPECT and slot detector can be accomplished without the coincidence circuit. SPECT and slot detector can independently record the time, energy and location of the photon arrivals, and compare the arrival time of two photons. If the arrival time is within a pre-defined duration, such as, 12 ns, the two photons are said to be detected synchronously.

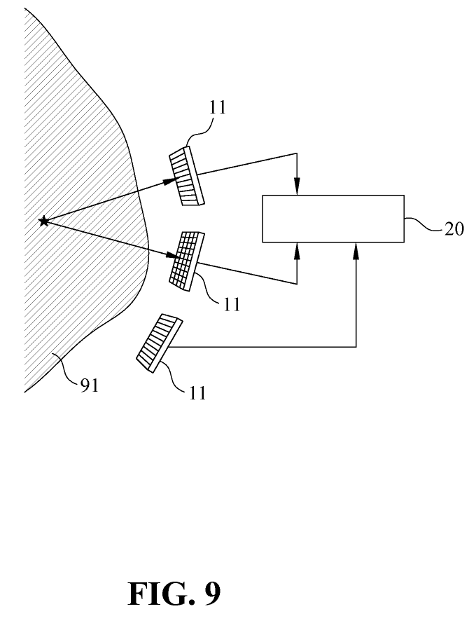

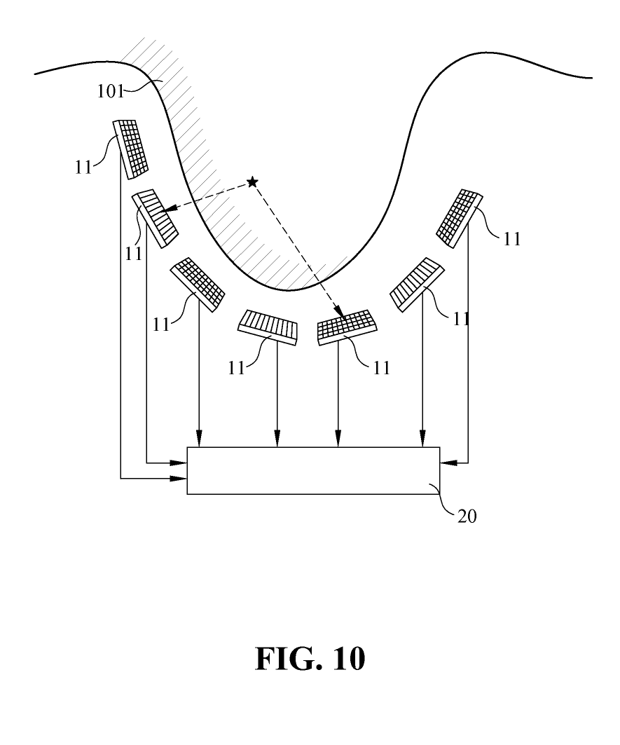

Refer to FIG. 9 and FIG. 10. FIG. 9 shows a schematic view of the present invention applied to thyroid tomography scanning, and FIG. 10 shows a schematic view of the present invention applied to breast tomography scanning. In both applications, modular detectors 11 are all connected to a coincidence circuit 20 and arranged according to the shape of thyroid 91 and breast 101 to be placed as close as possible to obtain the highest sensitivity.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A dual photons emission computed tomography (DuPECT) system, by using an isotope able to emit at least two photons during decay, said system comprising a coincidence circuit and a plurality of modular detectors connected to said coincidence circuit;
said modular detector further comprising a collimator, for defining trajectory of incident photons;
where said modular detectors being arranged surround an object to be detected during scanning.

2. The DuPECT system as claimed in claim 1, wherein said modular detector is a slot detector comprising a slot collimator.

3. The DuPECT system as claimed in claim 1, wherein said modular detector is a hole detector comprising a hole collimator.

4. The DuPECT system as claimed in claim 2, wherein said hole collimator is a pinhole collimator.

5. The DuPECT system as claimed in claim 2, wherein said hole collimator is a converging collimator.

6. The DuPECT system as claimed in claim 2, wherein said hole collimator is a parallel collimator.

7. The DuPECT system as claimed in claim 1, wherein said modular detector is a detection ring.
